(19) United States
(12) Patent Application Publication
(10) Pub. No.: US 2005/0209981 A1
(43) Pub. Date: Sep. 22, 2005

(54) Method of estimating the remaining lifetime of a part of a semiconductor fabrication machine by fuzzy inference

(76) Inventor: Nan-Jung Chen, Kaohsiung City (TW)

Correspondence Address: DUANE MORRIS, LLP;IP DEPARTMENT, ONE LIBERTY PLACE, PHILADELPHIA, PA, 19103-7396, US

(21) Appl. No.: 10/804,647

(22) Filed: Mar. 19, 2004

(51) Int. Cl. G06F 15/18; G06N 5/02; G06F 17/00

(52) U.S. Cl. 706/8; 706/47

(57) ABSTRACT

A method for estimating a remaining lifetime of a part in a piece of semiconductor fabrication equipment comprises the steps of: selecting a plurality of factors relevant to the remaining lifetime of the part, and estimating the remaining lifetime of the part by a fuzzy inference. The plurality of factors include a number of semiconductor wafers that have been processed by the piece of semiconductor fabrication equipment since the part was installed in the piece of equipment.

### FIELD OF THE INVENTION

The present invention relates to semiconductor fabrication generally, and more specifically to a method for estimating the remaining lifetime of a part of a piece of semiconductor fabrication equipment.

### BACKGROUND

Semiconductor fabrication is heavily dependent on the availability and reliability of fabrication equipment. The failure of a part of one piece of fabrication equipment can render that piece of equipment unusable, and can result in processing delays for all downstream processes, or reduction in production capacity until the part is replaced. Moreover, if the failure of a part is undetected, it can have unacceptable effects on the yield of the process.

Ideally, parts are replaced before they fail. However, there is currently no pre-alert system to warn the process engineer that a part of a semiconductor fabrication tool is likely to fail.

### SUMMARY OF THE INVENTION

A method for estimating a remaining lifetime of a part in a piece of semiconductor fabrication equipment, comprising the steps of: selecting a plurality of factors relevant to the remaining lifetime of the part, the plurality of factors including a number of semiconductor wafers that have been processed by the piece of semiconductor fabrication equipment since the part was installed in the piece of equipment; and estimating the remaining lifetime of the part by a fuzzy inference.

### BRIEF DESCRIPTION OF THE DRAWINGS

FIG. 1 is a block diagram of an exemplary system according to the present invention.

FIG. 2 is a table showing an exemplary input data set for the system of FIG. 1.

FIG. 3 is an example of a membership function for a first exemplary system.

FIG. 4 shows an example of determining membership in two fuzzy sets.

FIGS. 5A-5C show the fuzzy inference process for the example of FIG. 4.

FIGS. 6A and 6B show two membership functions for a second example according to the invention.

FIGS. 7A and 7B show the determination of membership in the two fuzzy sets of FIGS. 6A and 6B, respectively.

FIG. 8 is a table showing an exemplary fuzzy rule base for the example of FIGS. 6A and 6B.

FIGS. 9A-9D show application of the fuzzy rule set of FIG. 8 to the input data of FIGS. 7A and 7B.

FIG. 10 shows the fuzzy inference process for the example of FIGS. 6A and 6B.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation.

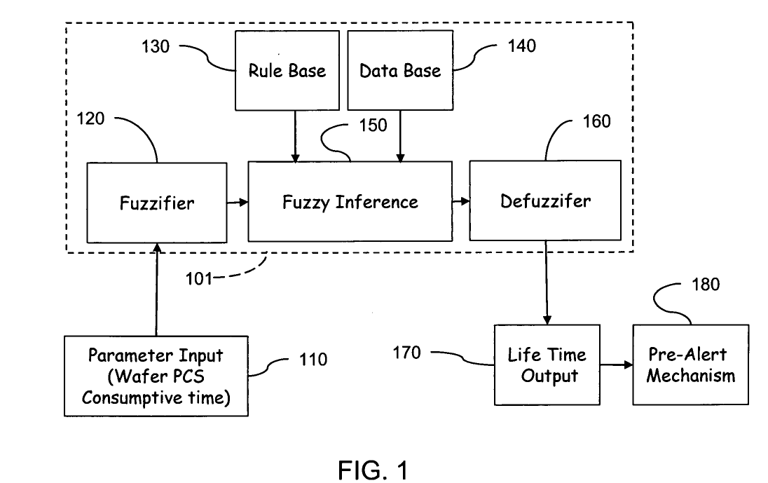

FIG. 1 is a block diagram of an exemplary system 100 for estimating a remaining lifetime of a part in a piece of semiconductor fabrication equipment. The system 100 includes a fuzzy control system 101. Basics of fuzzy logic control are described at http://www.mathworks.com/access/helpdesk/help/toolbox/fuzzy/fuzzyint.shtml, which is incorporated by reference herein in its entirety.

The system includes means 110 for automatically collecting and storing data representing the number of semiconductor wafers that have been processed by the piece of semiconductor fabrication equipment since the part was installed in the piece of equipment. For example, process control equipment collects data on the number of runs made by a given tool, and the corresponding application software takes account of the number of wafers processed by the tool in any given run. The data are then stored in a database (e.g., 140) on any convenient computer readable storage medium, such as a hard disk drive. The data collecting and storing means 110 may collect additional data relevant to the part's condition and expected remaining life. For example, the collecting and storing means 110 may collect data representing the length of time since the part was installed in the piece of equipment. For example, in the case of O-rings, the relevant parameters may be wafer count and cumulative usage time after installation. Also, in the case of a focus ring relevant parameters may be wafer count and cumulative usage time after installation. Also, in the case of the electrostatic chuck, the relevant parameters may be wafer count and cumulative usage time after installation.

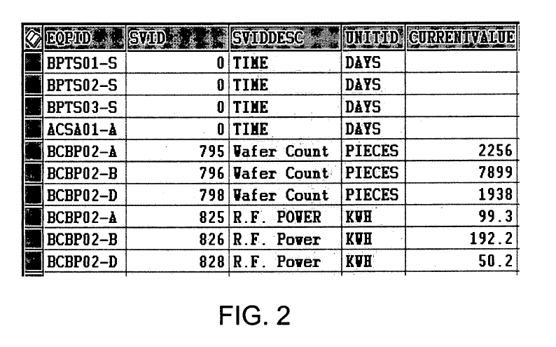

FIG. 2 is a table with exemplary data that may be input to a fuzzy control system 101. In FIG. 2, three types of data are shown: time in days since the part was installed in the corresponding piece of equipment, the number of wafer pieces processed since the part was installed, and the power.

A fuzzifier 120 determines how well the input data satisfy one or more of a plurality of descriptions, where the descriptions are permitted (but not required) to be vague. In traditional (“crispy”) set theory, an object either belongs to a set or does not belong to that set. In a fuzzy control system, an object is said to have a degree of membership between zero and one in a given fuzzy set. One example of a fuzzy set is the set of parts for which a “large” number of wafers have been processed by a piece of semiconductor fabrication equipment since the part was installed in that piece of equipment. The size, “large,” does not have an absolute definition. Because the degree of membership can be between zero and one, it is possible for a given object to have a non-zero degree of membership in two or more fuzzy sets.

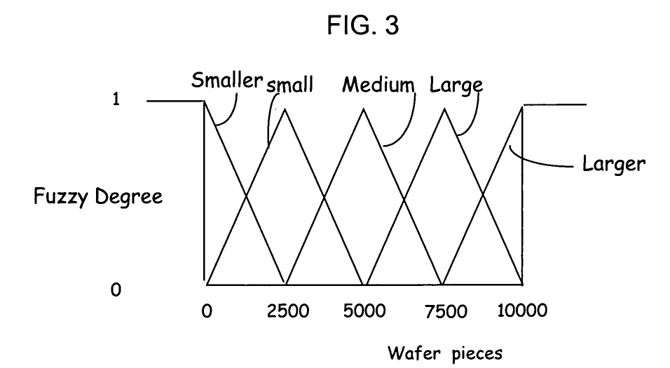

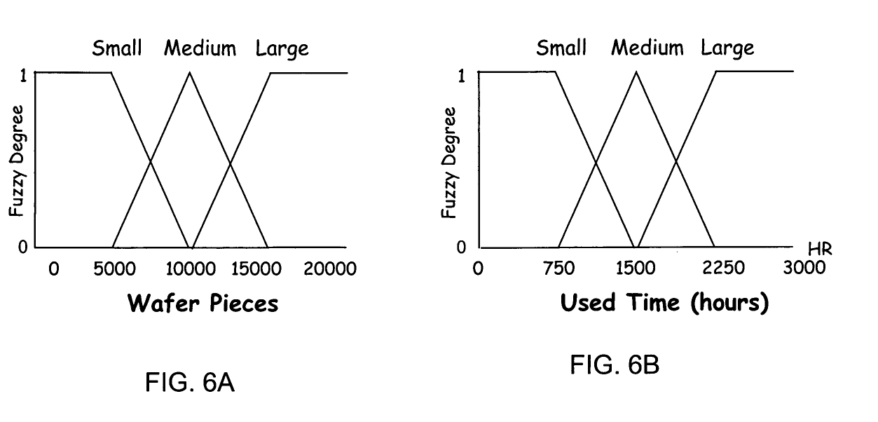

FIG. 3 is an example of a fuzzifier for a relatively simple system having one independent variable: the number of pieces processed by the equipment in which the part is installed, since the installation. (It will be understood that a preferred fuzzifier includes respective membership functions for more than one independent variable, such as in the example of FIGS. 6A-10). In FIG. 3, five fuzzy sets are introduced, each corresponding to a different size of the group of wafers processed by a piece of equipment since a part was installed. The five sizes in this example include: “smaller,” “small,” “medium,” “large” and “larger.” There is overlap between each pair of adjacent fuzzy sets. Thus, a part for which 2000 wafers have been processed by the equipment since installation of the part belongs to both the “smaller” and “small” fuzzy sets, and a part for which 9000 wafers have been processed by the equipment since installation of the part belongs to both the “large” and “larger” fuzzy sets.

For the simple fuzzifier shown in FIG. 3, the degree of membership in each function can be expressed as a piecewise linear function. Alternatively (particularly in the case of more complex membership functions, the membership function values can be stored in look-up tables, and the degree of membership for any intermediate value can be determined by interpolating between the two nearest values in the table for any given membership function. Thus, the membership functions can be polynomials, step functions, sinusoids, Gaussian distribution, sigmoid, or the like. The membership function values can be calculated, looked up, or interpolated using a programmed processor.

In the exemplary embodiment, the database 140 stores the fuzzy set data, defining the membership functions and the output sets.

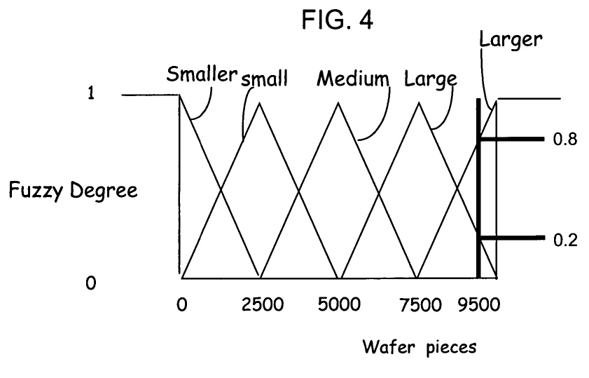

FIG. 4 shows how a part for which 9500 wafers have been processed since installation is mapped to the membership functions of FIG. 3. The value 9500 has a non-zero degree of membership for two of the five membership functions: “large,” and “larger.” More specifically, for the “large” fuzzy set, the degree of membership is 0.2. For the “larger” fuzzy set, the degree of membership is 0.8.

A fuzzy rule base 130 is provided. The fuzzy rule base relates the independent input variables to the outputs of the fuzzy controller 101. The fuzzy rules are acquired from the engineer's knowledge in the field. A fuzzy rule typically takes the form, “If x is A, then y is B,” where A (“the antecedent”) is a combination of one or more statements about the membership of the independent variables in one or more respective fuzzy sets, and B (the “consequent”) assigns a fuzzy set to the output. The fuzzy rules define the interaction of the various independent variables that affect the output of the fuzzy controller. The fuzzy rules may implement fuzzy operators such as “AND,” “OR,” and “NOT.” In the simplified example of FIGS. 3-5, the fuzzy rule set may be as follow:

(a) If the number of wafers processed is smaller, then the remaining life is longer.

(b) If the number of wafers processed is small, then the remaining life is long.

(c) If the number of wafers processed is medium, then the remaining life is medium.

(d) If the number of wafers processed is large, then the remaining life is short.

(e) If the number of wafers processed is larger, then the remaining life is shorter.

A fuzzy inference means 150 calculates the degree of fulfillment for each rule, calculates the fuzzy output of each rule, and aggregates the outputs of each rule.

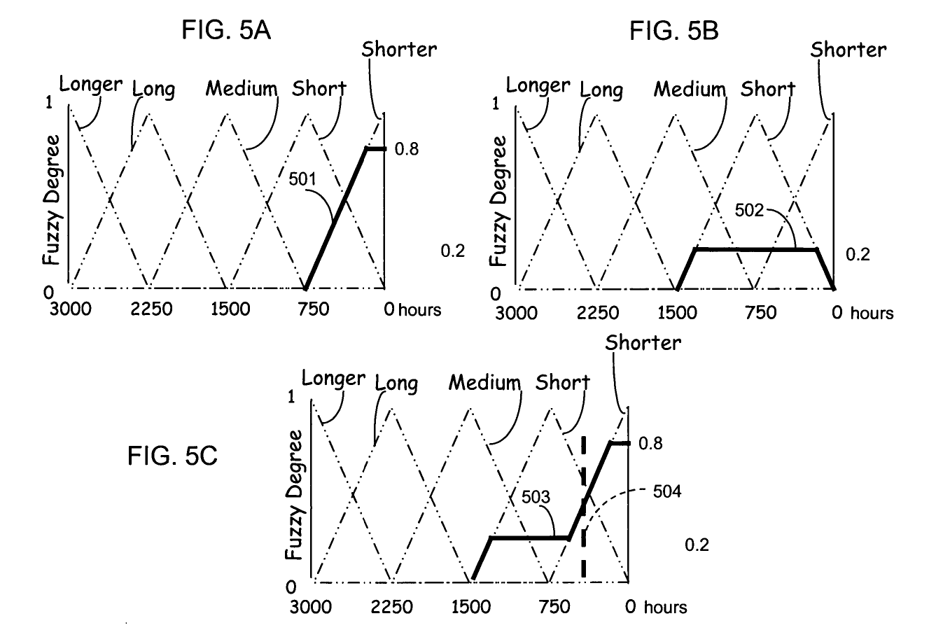

FIGS. 5A-5C show the possible output sets to which the input data can be mapped. The output sets correspond to the possible values of the consequent. FIGS. 5A and 5B show the calculation of the degree of fulfillment and fuzzy output for each rule, by the application of the rules to the input data set including a part for which the corresponding piece of equipment has processed 9500 wafers since installation of the part. In FIG. 5A, application of rule (e) provides a trapezoid portion 501 of the “shorter” output function, corresponding to degree of membership of 0.8. In FIG. 5B, application of rule (d) provides a trapezoid portion 502 of the “short” output function, corresponding to degree of membership of 0.2.

FIG. 5C shows how the fuzzy outputs of the various rules are aggregated to form a fuzzy output set 503. An area is formed representing the output set, by the union of the components output by each rule. FIG. 5C also shows the action of the defuzzifier according to a Mamdani method, wherein the crispy solution is found by the centroid 504 of the fuzzy set 503. In this example, the centroid 504 of the region 503 has an abscissa (X) value of about 400, indicating that the expected remaining lifetime for the part of this example is about 400 hours.

Block 170 performs the centroid computation to identify the remaining lifetime of the part. The aggregated output set 503 may be a complex function. Numerical integration methods provide effective techniques for finding the centroid of a complex shape.

Block 180 is a pre-alert mechanism to notify the user that a part is approaching the end of its lifetime. Alarms can be set to notify the relevant engineer based on a percentage of lifetime remaining (e.g., 10% of the nominal mean time between failure for the part), or based on a specific time value (e.g., 200 hours remaining). Any alarm technique may be used, including visual and/or auditory alarms, or launching of an electronic mail message to the engineer.

Use of fuzzy logic in the exemplary embodiments is particularly beneficial in simplifying computations when there are multiple input variables. An example of a set of fuzzy rules involving multiple input variables is provided further below with reference to FIGS. 6A-10.

Referring again to FIG. 1, a fuzzifier 120 determines the degree of membership for each fuzzy set. In the example of FIGS. 6A and 6B, the one or more factors include a number of semiconductor wafers that have been processed by the piece of semiconductor fabrication equipment since the part was installed in the piece of equipment (FIG. 6A), and the length of time the equipment in which the part is installed has been operated since the installation (FIG. 6B). Each of these factors has its own set of membership functions.

In FIG. 6A, there are three fuzzy sets: small, medium and large. If fewer than 5000 wafers are produced, the number of wafer pieces (P) is small, with a degree of membership of 1.0 (100%). Between 5000 and 10000 wafers, there is a non-zero degree of membership in the small and medium fuzzy sets. Between 10000 and 15000, there is a non-zero degree of membership in the medium and large fuzzy sets. For 15000 to 20000 pieces, the degree of membership in the large set is 1.0 (100%).

Similarly, in FIG. 6B, there are three fuzzy sets: small, medium and large. If the part has been used fewer than 750 hours, the number of hours used (T) is small, with a degree of membership of 1.0 (100%). Between 750 and 1500 wafers, there is a non-zero degree of membership in the small and medium fuzzy sets. Between 1500 and 2250, there is a non-zero degree of membership in the medium and large fuzzy sets. For 2250 to 3000 pieces, the degree of membership in the large set is 1.0 (100%).

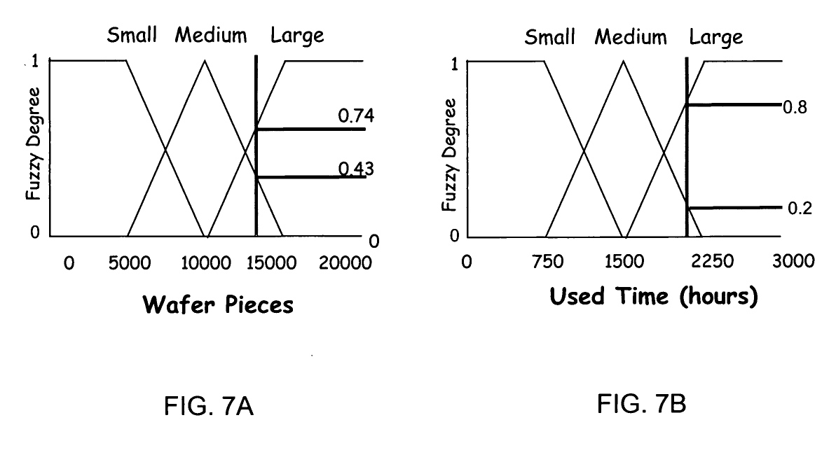

FIGS. 7A and 7B show application of the membership functions for a set of input data in which about 1300 wafers have been produced since the part was installed, and the part has been in use about 2000 hours. In FIG. 7A, the data indicate 0.74 degree of membership in the “large” fuzzy set, and about 0.43 degree of membership in the “medium” fuzzy set. Note that the degrees of membership in all of the sets do not necessarily add up to 1.0. In FIG. 7B, the degree of membership in the “large” fuzzy set is about 0.8, and about 0.2 degree of membership in the “medium” fuzzy set.

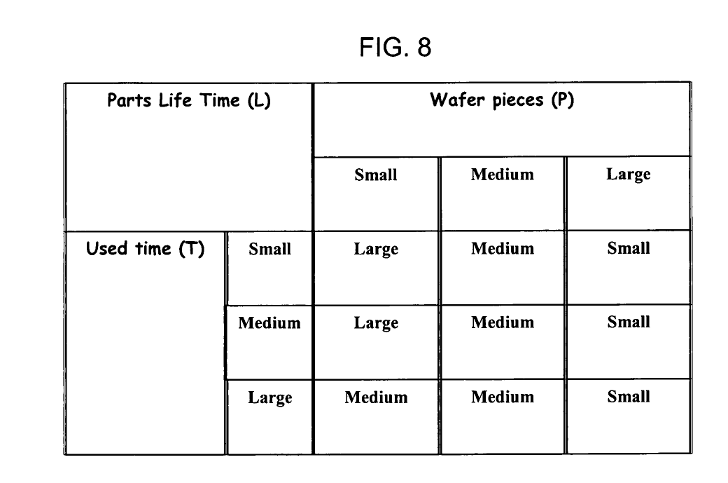

FIG. 8 is an exemplary rule set for this example. The following nine rules are shown in FIG. 8, in which P is the number of semiconductor wafers that have been processed by the piece of semiconductor fabrication equipment since the part was installed in the piece of equipment, T is the length of time that the part has been used, and L is the remaining lifetime of the part:

(a) if P is small, and T is small, then L is large;

(b) if P is medium, and T is small, then L is medium;

(c) if P is large, and T is small, then L is small;

(d) if P is small, and T is medium, then L is large;

(e) if P is medium, and T is medium, then L is medium;

(f) if P is large, and T is medium, then L is small;

(g) if P is small, and T is large, then L is medium;

(h) if P is medium, and T is large, then L is medium; and

(i) if P is large, and T is large, then L is small.

The fuzzy inference means 150 determines degrees of fulfillment of the plurality of rules based on a plurality of factors relevant to the remaining lifetime of the part.

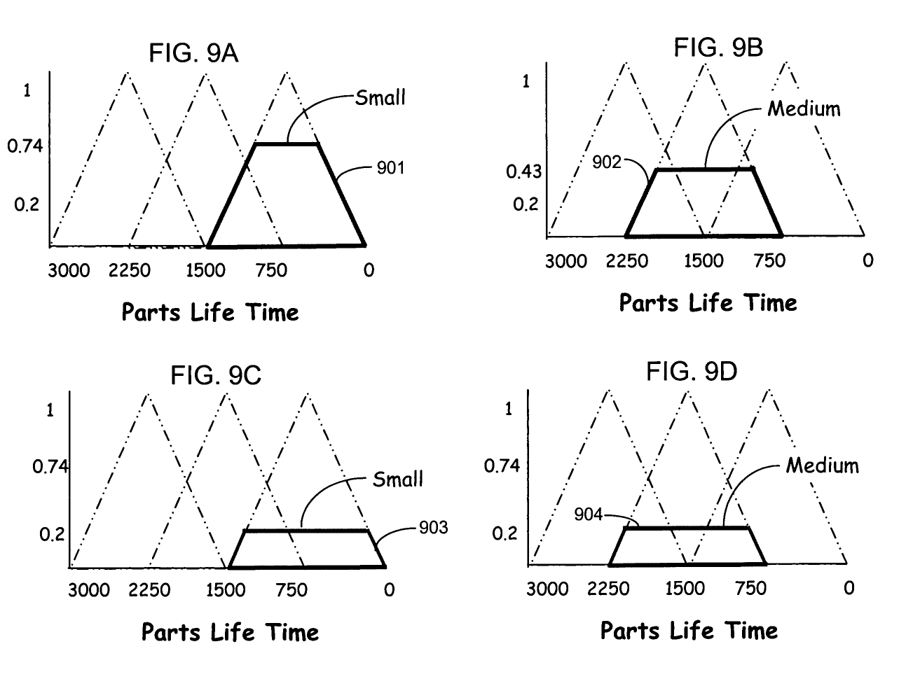

FIG. 9A shows the result of rule (i), when P is large (P=0.7) and T is large (T=0.8), then L is small. As is well known, in fuzzy operators, the AND operator is found by the minimum. Thus, for the L is small output set, the value is assigned the minimum of 0.74 and 0.8=0.74. The output set 901 for L is small is truncated at L=0.74.

FIG. 9B shows the result of rule (h), when P is medium (P=0.43) and T is large (T=0.8), then L is medium. For the L is medium output set, the value is assigned the minimum of 0.43 and 0.8=0.43. The output set 902 for L is medium is truncated at L=0.43.

FIG. 9C shows the result of rule (f), when P is large (P=0.74) and T is medium (T=0.2), then L is small. For the L is small output set, the value is assigned the minimum of 0.74 and 0.2=0.2. The output set for 903 L is small is truncated at L=0.2.

FIG. 9D shows the result of rule (e), when P is medium (P=0.43) and T is medium (T=0.2), then L is medium. For the L is medium output set, the value is assigned the minimum of 0.43 and 0.2=0.2. The output set 904 for L is medium is truncated at L=0.2.

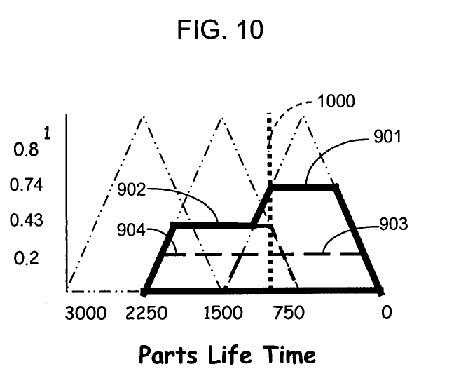

FIG. 10 shows the aggregation of the four sets 901-904. FIG. 10 also shows the result of the defuzzification by determining the centroid 1000 of the aggregated output set. In this example, the centroid is about 1000, which is the estimated remaining life of the part.

Although an exemplary Mamdani technique is shown in FIGS. 5C and 10, other defuzzification techniques, as taught by Sugeno may also be used.

The system described here can determine a part's life time based on any desired number of parameters. (For example, the life time of a chemical gas filter, a pure water filter, and a pump oil filter are all relative to wafer pieces produced and used time since installation. Although examples are provided above in which there are only one or two independent variables, the method is easily extended to more than two independent variables using standard fuzzy operators.

The exemplary system can reduce costs and allow the engineer to make the most use of the parts, by replacing parts near the ends of their expected lifetimes.

It's easy for the system to identify the status of parts' life time for various different units of parts. The database 140 can easily track the number of wafers processed since a part was installed, and the time since the part was installed.

The system also allows effective use of the acquired knowledge of equipment domain experts, to determine the fuzzy rules and which variables to focus on.

The system also provides an effective means for providing a pre-alert to equipment engineers to change parts based on the degree of consumption of the fuzzy sets.

The present invention may be embodied in the form of computer-implemented processes and apparatus for practicing those processes. The present invention may also be embodied in the form of computer program code embodied in tangible media, such as floppy diskettes, read only memories (ROMs), CD-ROMs, hard drives, ZIP™ disks, memory sticks, or any other computer-readable storage medium, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over the electrical wiring or cabling, through fiber optics, or via electromagnetic radiation, wherein, when the computer program code is loaded into and executed by a computer, the computer becomes an apparatus for practicing the invention. When implemented on a general-purpose processor, the computer program code segments configure the processor to create specific logic circuits.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

1. A method for estimating a remaining lifetime of a part in a piece of semiconductor fabrication equipment, comprising the steps of:
selecting a plurality of factors relevant to the remaining lifetime of the part, the plurality of factors including a number of semiconductor wafers that have been processed by the piece of semiconductor fabrication equipment since the part was installed in the piece of equipment; and
estimating the remaining lifetime of the part by a fuzzy inference.

2. The method of claim 1, wherein the plurality of factors include a length of time that the part has been used.

3. The method of claim 2, further comprising replacing the part when the estimated remaining lifetime falls below a threshold value.

4. The method of claim 2, wherein the fuzzy inference is based on the following fuzzy rule set, in which P is the number of semiconductor wafers that have been processed by the piece of semiconductor fabrication equipment since the part was installed in the piece of equipment, T is the length of time that the part has been used, and L is the remaining lifetime of the part:
if P is small, and T is small, then L is large;
if P is medium, and T is small, then L is medium;
if P is large, and T is small, then L is small;
if P is small, and T is medium, then L is large;
if P is medium, and T is medium, then L is medium;
if P is large, and T is medium, then L is small;
if P is small, and T is large, then L is medium;
if P is medium, and T is large, then L is medium; and
if P is large, and T is large, then L is small.

5. The method of claim 2, wherein the fuzzy inference is based on a fuzzy rule set determined using empirical experience.

6. The method of claim 2, further comprising the step of automatically collecting the following data for the part: the number of semiconductor wafers that have been processed by the piece of semiconductor fabrication equipment since the part was installed in the piece of equipment, and the length of time that the part has been used.

7. The method of claim 1, wherein:
the plurality of factors include a length of time that the part has been used;
wherein the fuzzy inference is based on the following fuzzy rule set determined using empirical experience, in which P is the number of semiconductor wafers that have been processed by the piece of semiconductor fabrication equipment since the part was installed in the piece of equipment, T is the length of time that the part has been used, and L is the remaining lifetime of the part:
if P is small, and T is small, then L is large;
if P is medium, and T is small, then L is medium;
if P is large, and T is small, then L is small;
if P is small, and T is medium, then L is large;
if P is medium, and T is medium, then L is medium;
if P is large, and T is medium, then L is small;
if P is small, and T is large, then L is medium;
if P is medium, and T is large, then L is medium; and
if P is large, and T is large, then L is small.

8. A system for estimating a remaining lifetime of a part in a piece of semiconductor fabrication equipment, comprising:
means for automatically collecting and storing data representing the number of semiconductor wafers that have been processed by the piece of semiconductor fabrication equipment since the part was installed in the piece of equipment;
fuzzy inference means for determining degrees of fulfillment of a plurality of rules based on a plurality of factors relevant to the remaining lifetime of the part, the plurality of factors including a number of semiconductor wafers that have been processed by the piece of semiconductor fabrication equipment since the part was installed in the piece of equipment; and
a defuzzifier for estimating the remaining lifetime of the part based on the degrees of fulfillment of the plurality of rules.

9. The system of claim 8, wherein the plurality of factors include a length of time that the part has been used.

10. The system of claim 9, wherein the rules include the following fuzzy rule set, in which P is the number of semiconductor wafers that have been processed by the piece of semiconductor fabrication equipment since the part was installed in the piece of equipment, T is the length of time that the part has been used, and L is the remaining lifetime of the part:
if P is small, and T is small, then L is large;
if P is medium, and T is small, then L is medium;
if P is large, and T is small, then L is small;
if P is small, and T is medium, then L is large;
if P is medium, and T is medium, then L is medium;
if P is large, and T is medium, then L is small;
if P is small, and T is large, then L is medium;
if P is medium, and T is large, then L is medium; and
if P is large, and T is large, then L is small.
